(19) United States
(12) Patent Application Publication
(10) Pub. No.: US 2010/0040136 A1
(43) Pub. Date: Feb. 18, 2010

(54) METHOD FOR PERFORMING BINARIZATION USING A LOOKUP TABLE

(75) Inventor: Doron Sabo, Natanya (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: HORIZON SEMICONDUCTORS LTD., Herzliya (IL)

(21) Appl. No.: 12/190,711

(22) Filed: Aug. 13, 2008

(51) Int. Cl. H04N 11/02

(52) U.S. Cl. 375/240.02; 375/240.01

(57) ABSTRACT

The present invention also relates to a binarization method for generating a binary sequence, comprising the steps of: (a) receiving a Syntax Element with its binarization parameters; (b) acquiring the corresponding binarization scheme of said Syntax Element using an updateable lookup table; (c) transforming said Syntax Element value into a corresponding binary sequence; (d) acquiring a Context Index, a bypass flag and a terminate flag for each of the bins of said corresponding binary sequence using said lookup table; (e) attaching each of said Context Indexes, said bypass flags, and said terminate flags to its bin of said corresponding binary sequence; and (f) generating said bins of said corresponding binary sequence, their said Context Indexes, said bypass flags, and said terminate flags.

### FIELD OF THE INVENTION

The present invention relates to the field of implementing video encoding schemes. More particularly, the invention relates to a method for implementing the binarization part of the CABAC encoding scheme using a lookup table.

### BACKGROUND OF THE INVENTION

The increasing demand to improve the quality of transmitted video has prompted rapid advancements in video compression techniques. During the last decade, many ISO/ITU standards on video compression have evolved, such as standard ISO/14496-10.2005 AVC referred to hereinafter as the H.264 standard. This standard exploits the spatio-temporal correlation in the video data and utilizes entropy coding techniques to achieve a high compression ratio. Entropy coding is a loss-less compression process that is based on the statistical properties of data. The entropy machines first assign codes to symbols so as to match code lengths with the probabilities of occurrence of the symbols. The basic idea is to express the most frequently occurring symbols with the least number of bits.

Some of the commonly used Entropy coding techniques used in video compression include Golomb coding, Hauffman coding and arithmetic coding. The main idea behind arithmetic coding is to assign an interval to a sequence of symbols. Starting with the interval [0->1), it is divided into several subintervals, which sizes are proportional to the current probability of the corresponding symbols. The subinterval corresponding to the first symbol is then taken as the interval for the next symbol, and so on. At the end of the process the output is the subinterval corresponding to the last symbol. At this point the arithmetic encoder selects an optimized fractional number from within the borders of the last subinterval, which represents the initial sequence of symbols. Thus an arithmetic encoder is capable of converting a sequence of data symbols into an optimized single fractional number.

Due to its high compression efficiency, the Arithmetic coding has been chosen for the H.264 standard as the higher compression mode. The H.264 supported arithmetic coding is combined with context-adaptive modeling techniques and is known as the Context-based Adaptive Binary Arithmetic Coding (CABAC). The context-adaptive modeling techniques use local spatial and temporal characteristics to estimate the probability of a symbol. Thus, context-adaptive modeling has shown an even better compression results compared to the other forms of coding, as the successful entropy coding depends largely on accurate models of symbol probability.

The CABAC encoding algorithm includes two basic steps: binarization and binary arithmetic encoding. In the binarization step, a syntax element is mapped to a unique binary sequence. In the H.264 standard, the binarization mappings are either specifically defined or are obtained by a combination of four elementary binarization processes. The four elementary binarization processes are Unary binarization process, the Truncated Unary binarization process, the Concatenated Unary/K-th order Exp-Golomb binarization process, and the Fixed-Length binarization process. Each bit of the binary sequence, referred to hereinafter as bin, is passed through a context modeling stage, where a Context-Index is attached to each bin. The Context-Index (CI) indicates the chosen context-dependent probability model for the attached bin. The bin, along with its CI, is then passed on to the arithmetic encoding engine, where coding of the bin takes place and the probability model is updated.

In some of the cases, where the encoder is part of a setup box or part of any system which receives a continual bitstream of video, any delay in processing and encoding of the received video data may result in lose of data, an incident which is unacceptable. Therefore, in order to obtain a fast binarization process the binarization algorithm is preferably implemented in ASIC hardware. The implementation of video encoding in hardware allows the system to perform the complex encoding calculations in a rapid rate which can sometimes be crucial for in the video encoding process. However, once the binarization algorithm is implemented in hardware it may lose its flexibility in terms of updating and debugging as hardware modifications can be very costly.

It is an object of the present invention to provide a method for implementing the binarization process in hardware.

It is another object of the present invention to provide a method for adding flexibility to the hardware implemented binarization process.

It is still another object of the present invention to provide a method for easily and efficiently modifying parameters of the hardware implemented binarization process.

Other objects and advantages of the invention will become apparent as the description proceeds.

### SUMMARY OF THE INVENTION

The present invention relates to a system for performing binarization comprising: (a) an updateable lookup table for storing a plurality of Syntax Element types, their corresponding binarization schemes, their corresponding Context Indexes constructing parameters, their corresponding bypass flags, and their corresponding terminate flags; (b) a hardware implemented Binarization Machine, logically connected to said lookup table, and capable of: (1) receiving a Syntax Element with its binarization parameters; (2) acquiring the corresponding binarization scheme of said Syntax Element using said lookup table; (3) transforming said Syntax Element value into a corresponding binary sequence; (4) acquiring a Context Index, a bypass flag and a terminate flag for each of the bins of said corresponding binary sequence using said lookup table; (5) attaching each of said Context Indexes, said bypass flags and said terminate flags to its bin of said corresponding binary sequence; (6) outputting said bins of said corresponding binary sequence, their said Context Indexes, said bypass flags, and said terminate flags; and (c) a Microcode Unit for controlling said Binarization machine and for feeding said Syntax Element and its binarization parameters into said Binarization machine.

In one embodiment, the output of the Binarization Machine is connected to a CABAC Engine.

Preferably, a FIFO repository is connected between the Binarization Machine and the CABAC Engine.

In one embodiment, the output of the Binarization Machine is connected to a Microcode Unit.

The present invention also relates to a binarization method for generating a binary sequence, comprising the steps of: (a) receiving a Syntax Element with its binarization parameters; (b) acquiring the corresponding binarization scheme of said Syntax Element using an updateable lookup table; (c) transforming said Syntax Element value into a corresponding binary sequence; (d) acquiring a Context Index, a bypass flag and a terminate flag for each of the bins of said corresponding binary sequence using said lookup table; (e) attaching each of said Context Indexes, said bypass flags, and said terminate flags to its bin of said corresponding binary sequence; and (f) generating said bins of said corresponding binary sequence, their said Context Indexes, said bypass flags, and said terminate flags.

### BRIEF DESCRIPTION OF THE DRAWINGS

In the drawings:

FIG. 1 is a schematic diagram of a prior art implementation of a fast CABAC machine.

FIG. 2 is a schematic diagram of an implementation of a fast CABAC machine according to one of the embodiments of the invention.

### DETAILED DESCRIPTION OF PREFERRED EMBODIMENTS

The following terms are described explicitly:

Syntax Element (SE)—is a basic element of data, intended for processing and encoding by the system of the invention in order to generate a CABAC encoded bitstream. Different SEs can represent different types of data (e.g. motion vectors, DCT coefficients, etc.)

Binarization—the process of transforming a SE to a corresponding binary sequence.

Bin—a bit from the binary sequence that has been produced by the binarization process.

Binstream—a stream of bins, constructed of the concatenated bins at the output of the binarization process.

Context Index (CI)—an index for indicating the chosen context-dependent probability model for the accompanying bin.

Binarization parameters—are data elements which represent information on the manner for applying binarization on the accompanying SE and information on the manner for attaching Context-Indexes (CIs) to the output bins.

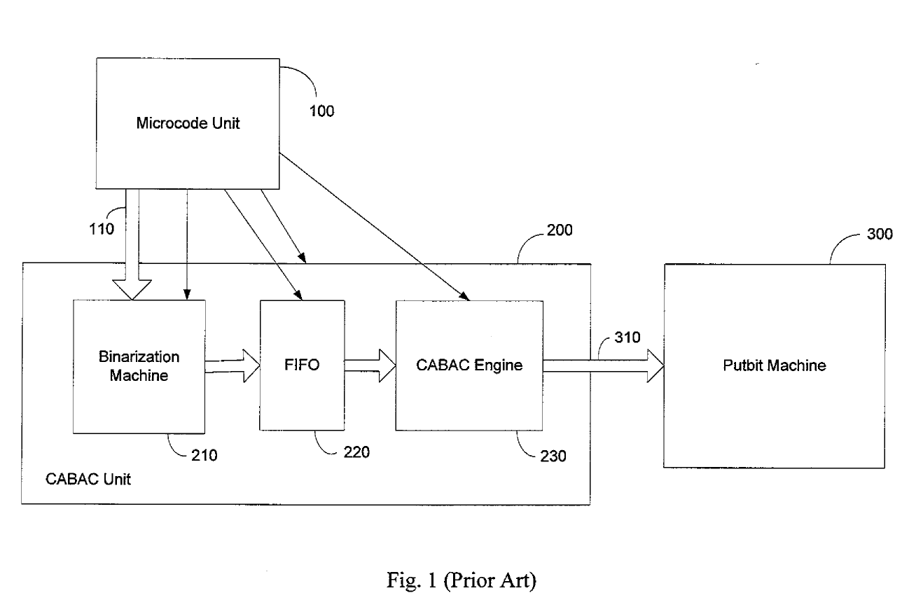

FIG. 1 is a schematic diagram of a prior art implementation of a fast CABAC machine. The Microcode Unit (MU) 100 is used for feeding SEs, and their accompanying binarization parameters, into the CABAC unit 200, over bus 110, and for controlling the CABAC unit 200 and its internal units. By MU it is meant to include any system capable of controlling and feeding SEs to a CABAC unit, such as a CPU, a hardware state machine, etc. Each SE, fed by the MU 100 to the CABAC Unit 200, is then encoded according to the CABAC encoding algorithm specified in the H.264 standard. After CABAC encoding, the output is fed into the Putbit machine 300, over bus 310, where the Putbit machine 300 combines the outputs to a bitstream for transmission. The CABAC unit 200 comprises 3 internal units: the Binarization Machine (BM) 210, the FIFO repository 220, and the CABAC Engine 230. In the BM 210, each SE is mapped to a binary sequence. As stated in the H.264 standard, the binarization process depends firstly on the SE's type. The H.264 standard lists many types of SEs and their corresponding binarization schemes. The H.264 standard further reveals that the binarization scheme can either map to a set sequence or to a combination of one or more of the elementary binarization transforms. The four elementary binarization transforms, as disclosed in the h.264 standard, are the Unary binarization transform, the Truncated Unary binarization transform, the Concatenated Unary/K-th order Exp-Golomb binarization transform, and the Fixed-Length binarization transform. Once the corresponding binary sequence is obtained, each of its bins is then passed through a context modeling stage for determining its corresponding CI. The CI is determined by calculating each bin's context-dependent probability model. Once found, the CI is attached to its corresponding bin. All the bins along with their accompanying CIs are then passed on to FIFO repository 220, where they await insertion into CABAC Engine 230. After a bin is transferred from FIFO 220 to the CABAC Engine 230, it is coded in the CABAC Engine 230 according to the CABAC algorithm, as described in the standard H.264, and the probability model is updated according to the attached CI. Due to the above mentioned constraints, this described prior art system is implemented in hardware and the described binarization schemes are hard wired in the hardware of BM 210.

As stated in the H.264 standard, each bin can be encoded using one of three methods: (1) Normal encoding, using the probabilities as indexed by its attached CI, (2), Bypass encoding and (3) Terminate encoding. Hence, two flags are attached to each bin, to specify the encoding method to be used: bypass_flag and terminate_flag. The bypass flag is used to mark a bin that has a probability close to 0.5 for each possible value of ‘1’ or ‘0’. The CABAC Engine processes bins differently, if their bypass_flag is on. The terminate flag is used to indicate a possible end of the binstream.

For the sake of brevity an example is set forth of encoding a SE of an ‘mb_qp_delta’ type having a value of 6, according to the prior art implementation described in relations to FIG. 1. The SE is first fed by MU 100 to the BM 210. As stated in the 11.264 standard, the binarization scheme of a SE of ‘mb_qp_delta’ type is Unary. The Unary binarization scheme is generally carried out by transforming the value of the SE to a binary sequence having a number of ‘1’s equal to the value of the SE and a ‘0’ at its end. Therefore, the BM 210 transforms the value of ‘6’ to the binary sequence ‘1111110’, calculates a corresponding CI for each of the bins, and attaches the bypass and terminate flags. The process of calculating a CI is disclosed in the H.264 standard, The 7 bins, together with their corresponding CIs and flags are then fed into FIFO 220. FIFO 220 then feeds each bin, its corresponding CI and flags into CABAC Engine 230 for encoding, according to the CABAC algorithm as described in the H.264 standard.

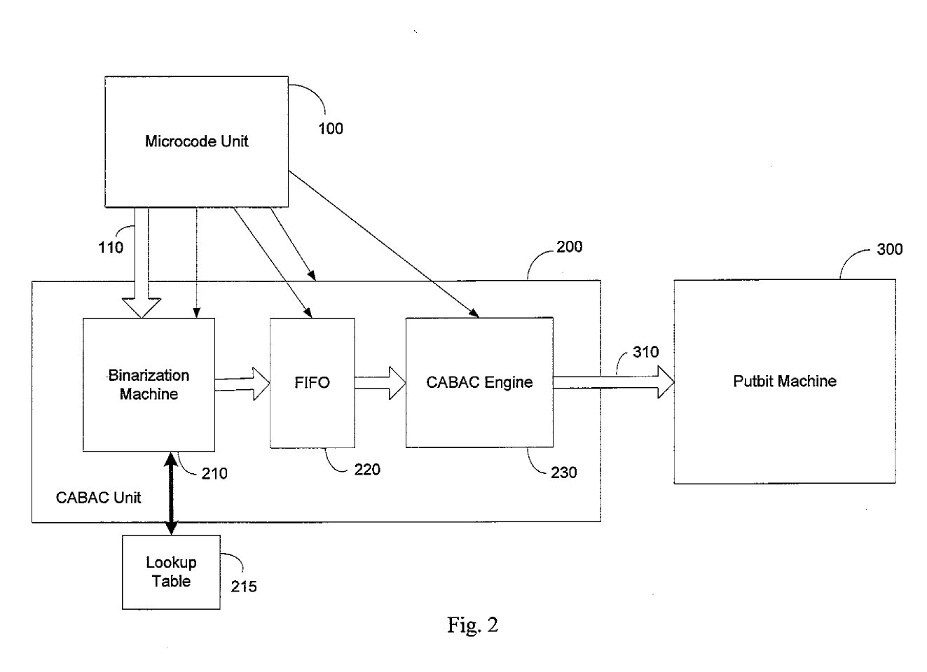

FIG. 2 is a schematic diagram of an implementation of a fast CABAC machine according to one of the embodiments of the invention. In this embodiment FIFO 220, CABAC Engine 230 and Putbit Machine 300 operate in essentially the same way as described in relations to FIG. 1 However, in this embodiment a new logical unit is added, an auxiliary lookup table 215. The lookup table 215 can be implemented on an updateable medium. By updateable medium it is meant to include any media that can be updated without changing the hardware, e.g. media that can be re-written from firmware/software, including RAM, Hard Disk, Flash Disk, internal cache, ROM or any other updateable medium. In one of the embodiments, this updateable media can be updated by the MU 100 running a firmware, as well as by other microcode machines or by an embedded general purpose CPU on which the software of the system is running. The lookup table 215 lists all the required SE types, their corresponding binarization scheme, their corresponding CIs, and their corresponding bypass and terminate flags. Although the lookup table 215 is not restricted to any number of entries of SE types, preferably there are more than 30 such entry types, according to this embodiment. In this embodiment when MU 100 feeds a SE, with its accompanying binarization parameters, into BM 210, using bus 110, BM 210 first reads the type of the SE from the binarization parameters and allocates the corresponding binarization scheme in the connected lookup table 215. After SM 210 allocates the correct binarization scheme in the lookup table 215, it applies that binarization scheme to the SE for producing the corresponding binary sequence. In addition, BM 210 also allocates the correct CI, bypass flag and terminate flag to each bin according to the information supplied by the lookup table 215. Thus the role of the lookup table 215 is primary and essential in the binarization process Changes within the lookup table 215 can affect the outcome of the binarization process. Once the SE has been processed by BM 210, the output bins, their corresponding CIs and flags are then fed to the FIFO repository 220. From FIFO repository 220 the output bins, their corresponding CIs and flags are fed to CABAC Engine 230 for CABAC encoding, as described in the standard H.264, and the probability model is updated according to the attached CIs.

The method of the invention, according to the embodiment described in relations to FIG. 2, provides an implementation that combines hardware and updateable data. In other words, the described implementation provides a fast binarization process capable of coping with the required bitrates on one hand and provides flexibility to that same binarization process, after hardware implementation, on the other hand. For example, assuming a SE of an ‘mb_qp_delta’ type has a large value which its corresponding binary sequence is larger than the FIFO repository 220 can hold. By adding another 2 binary schemes to lookup table 215 the SE and its large value can be processed. The 2 binary schemes may belong to 2 new types of SEs, for example: ‘long_mb_qp_delta_begin’ and ‘long_mb_qp_delta_cont’. These new types of binary schemes can be defined according to the desired output. For instance, if the SE of an ‘mb_qp_delta’ type has a value of 48, which can produce a binary sequence larger than the FIFO repository 220 can store, MU 100 can divide the SE value in 2 halves. The first half can be tagged as belonging to the ‘long_mb_qp_delta_begin’ type, and the second half can be tagged as belonging to the ‘long_mb_qp_delta_cont’. Then the first half of the SE value, which is 24 for example, is fed by MU 100 to the BM 210. The BM 210 receives the first half of the SE, reads the type of the SE from the binarization parameters and allocates the corresponding binarization scheme in the connected lookup table 215. In the lookup table ‘long_mb_qp_delta_begin’ type can map to a Truncated Unary binarization scheme having the max_value of 24 in order to obtain the required output binary sequence of ‘111111111111111111111’ (24 ones). As described before, the CIs, the bypass flags, and the terminate flags are also calculated for each bin. Then the second half of the SE value (24) is fed by MU 100 to the BM 210. The BM 210 receives the second half, reads the type of the SE from the binarization parameters and allocates the corresponding binarization scheme in the connected lookup table 215. In the lookup table ‘long_mb_qp_delta_cont’ type can map to a Unary binarization scheme having the max_value of 24 in order to obtain the required output binary sequence of ‘111111111111111111110’ (24 ones and one zero). Thus the halves can be fed into CABAC Unit 200 one by one, effectively achieving the desired result, without overloading the FIFO 220. The outcome of processing both halves will be the same as processing the whole initial value as the concatenating of both halves produces ‘111111111111111111111111111111111111111110’ (48 ones and one zero) as the binarization required by the standard. In other examples, the SE value may be divided into mare than 2 parts, and the parts may have different values according to the varying needs and requirements.

The invention may also be used for updating the system in case the standard is changed or extended. For example, if a new binarization scheme is added to the standard, no hardware modifications are required. In addition the invention may be used for fixing bugs in hardware. For example if the hardware does not process one of the binarization schemes correctly, the lookup table may be updated to include the specific binary sequence outcome for that specific scenario. Thus in that specific scenario the outcome will not be processed, effectively circumnavigating the bug.

As understood the implementing of a process in hardware using an updateable lookup table may be used for any other binarization processes, encoding schemes or other implementations as well.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the invention or exceeding the scope of claims.

1. A system for performing binarization comprising:
a. an updateable lookup table for storing a plurality of Syntax Element types, their corresponding binarization schemes, their corresponding Context Indexes constructing parameters, their corresponding bypass flags, and their corresponding terminate flags;
b. a hardware implemented Binarization Machine, logically connected to said lookup table, and capable of:
i. receiving a Syntax Element with its binarization parameters;
ii. acquiring the corresponding binarization scheme of said Syntax Element using said lookup table;
iii. transforming said Syntax Element value into a corresponding binary sequence;
iv. acquiring a Context Index, a bypass flag and a terminate flag for each of the bins of said corresponding binary sequence using said lookup table;
v. attaching each of said Context Indexes, said bypass flags and said terminate flags to its bin of said corresponding binary sequence;
vi. outputting said bins of said corresponding binary sequence, their said Context Indexes, said bypass flags, and said terminate flags; and
c. a Microcode Unit for controlling said Binarization machine and for feeding said Syntax Element and its binarization parameters into said Binarization Machine.

2. A system according to claim 1, where the output of the Binarization Machine is connected to a CABAC Engine.

3. A system according to claim 2, where a FIFO repository is connected between the Binarization Machine and the CABAC Engine.

4. A system according to claim 1, where the output of the Binarization Machine is connected to a Microcode Unit.

5. A binarization method for generating a binary sequence, comprising the steps of:
a. receiving a Syntax Element with its binarization parameters;
b. acquiring the corresponding binarization scheme of said Syntax Element using an updateable lookup table;
c. transforming said Syntax Element's value into a corresponding binary sequence;
d. acquiring a Context Index, a bypass flag and a terminate flag for each of the bins of said corresponding binary sequence using said lookup table;
e. attaching each of said Context Indexes, said bypass flags, and said terminate flags to its bin of said corresponding binary sequence; and
f. generating said bins of said corresponding binary sequence, their said Context Indexes, said bypass flags, and said terminate flags.
